(19) United States
(12) Patent Application Publication
(10) Pub. No.: US 2015/0294238 A1
(43) Pub. Date: Oct. 15, 2015

(54) TRAVEL PLANNING SYSTEM

(71) Applicant: Amadeus S.A.S., Sophia Antipolis (FR)

(72) Inventors: David Benque, Mouans Sartoux (FR); Edmond Abboud, Antibes (FR); Cedric Lamoriniere, Juan Les Pins (FR)

(73) Assignee: Amadeus S.A.S., Sophia Antipolis (FR)

(21) Appl. No.: 14/248,535

(22) Filed: Apr. 9, 2014

(51) Int. Cl. G06Q 10/02

(52) U.S. Cl. CPC G06Q 10/025

(57) ABSTRACT

Methods, systems, and computer program products for generating travel proposals that satisfy traveler defined stopover and segment time and activity constraints. A travel planning module receives data relating to a travel request from a traveler. The travel request may include data defining an origin, a destination, and a trip constraint requiring a stopover. The travel planning module determines a minimum number of segments required to satisfy the trip constraints, and generates a set of routes with each route comprising a number of links greater than or equal to the minimum number of required segments. The travel planning module may then populate each of the routes with scheduled segments to generate a plurality of candidate travel proposals based on data received from a scheduling database. Candidate travel proposals that do not satisfy the trip constraints may be discarded, and the remaining candidate travel proposals displayed to the traveler.

### BACKGROUND

The invention generally relates to computers and computer software, and in particular to methods, systems, and computer program products for generating travel proposals based on traveler defined constraints.

Travel planning programs are available that facilitate planning of trips by combining carrier segments, such as trains or flights, into one or more travel proposals that connect an origin to a destination. One or more of the travel proposals may then be presented to a traveler or travel agent based on criteria such as a travel time or price.

Conventional travel planning systems are based on search engines that determine a “best” travel proposal between the origin and destination based on preselected traveler preferences and optimization rules embedded in the search engine. Traveler preferences that may be entered typically include distance or travel time and cost criteria, with the traveler typically identifying whether they want to prioritize speed or cost. In the case where speed is the priority, the travel planning system will typically return the shortest or quickest travel proposals between the origin and destination. In the case where cost is the primary concern, the travel planning system may present the lowest cost travel proposals to the traveler. In either case, the traveler may provide the desired origin, destination, departure time, and arrival time to the travel planning program. The travel planning program may then determine and compare the possible travel options between the origin and destination for periods of time corresponding to the requested departure and arrival times.

In some cases, the travel planning system may use data provided by a computer reservation system to generate travel proposals. Computer reservation systems typically include one or more databases that store and retrieve information on travel product cost and availability. Computer reservation systems may also conduct transactions related to booking air, rail, shuttle, or bus segments, hotel rooms, rental cars, and other travel related services. A computer reservation system configured to book reservations for multiple travel service providers is commonly referred to as a Global Distribution System (GDS). A GDS is typically operated by a third party service provider, such as Amadeus IT Holding SA. Third party service providers may offer GDS services that connect travel service provider systems to indirect seller systems. The GDS may thereby enable the indirect sellers to search for and sell travel services offered by multiple travel service providers. Indirect sellers such as travel agencies may subscribe to the GDS to access travel information and book reservations for travel services provided by the travel service providers. When booking travel products for a traveler, travel agents may determine available carrier segments that connect the requested origin and destination using data provided by the GDS. Thus, travelers may be provided with indirect access to the GDS through the subscribing travel agency.

On-line travel agency systems may provide travelers with access to data retrieved from the GDS via the Internet, thereby allowing travelers to shop for travel products autonomously. To this end, on-line travel agency systems may be coupled to the GDS to access travel information such as available segments and prices, and may use a travel planning program to search for travel products. The traveler may access the travel agency system and input travel criteria over the Internet using a web browser. The travel agency system may then access travel information and/or reserve travel products such as flights, hotel rooms, or rental cars and display the results to the traveler via the browser.

Conventional travel planning systems typically determine which travel proposals to display to travelers by simply selecting segments that provide travel proposals having the fewest connections, the shortest total travel time, or the lowest cost. Travel proposals may also be filtered so that the travel proposals are limited to segments provided by a particular carrier or that offer a particular feature, such as first class seating. Thus, the travel proposals provided to travelers by conventional travel planning systems generally represent a compromise between the time spent traveling, a desired level of comfort, and the cost of the travel services.

In some cases, travelers may have particular needs that require unconventional travel arrangements, such as trips having scheduled stopovers during which they can disembark from the conveyance or predetermined segment lengths. Because conventional travel planning systems simply optimize travel proposals based on the quickest or cheapest available travel proposals, they are not capable of accounting for these types of travel constraints. The traveler or the travel agent must therefore manually select travel arrangements that satisfy the traveler's time constraints. This typically requires separately searching for and booking trip segments so that the trip includes stopovers or segments that satisfy the traveler's constraints. Such a trial-and-error approach is cumbersome at best, and is unlikely to return an optimal travel proposal since selections are made sequentially based on artificial limitations imposed by the manual process. This may be especially so with complex travel arrangements.

Thus, improved systems, methods, and computer program products for automated travel planning are needed that enable travelers to set trip constraints that include planned stopovers and required segment lengths.

### SUMMARY

In an embodiment of the invention, a method of generating a travel proposal for travel between an origin and a destination is provided. The method includes receiving a travel request including data defining the origin, the destination, and a trip constraint requiring a stopover. The method may determine a combination of segments connecting the origin to the destination. The combination of segments may satisfy the trip constraint, and may include a first segment and a second segment connected by the stopover. The method may further define the travel proposal to include the combination of segments.

In another embodiment of the invention, an apparatus for generating the travel proposal for travel between the origin and the destination is provided. The apparatus includes a processor and a memory coupled to the processor. The memory may include instructions that, when executed by the processor, cause the apparatus to receive the travel request including the data defining the origin, the destination, and the trip constraint requiring the stopover. The instructions may further cause the apparatus to determine the combination of segments connecting the origin to the destination that satisfies the trip constraint, and that includes the first segment and the second segment connected by the stopover. The instructions may further cause the apparatus to define the travel proposal to include the combination of segments.

In another embodiment of the invention, a computer program product is provided that includes a non-transitory computer readable storage medium including instructions. The instructions may be configured, when executed by the processor, to cause the processor to receive the travel request including the data defining the origin, the destination, and the trip constraint requiring the stopover. The instructions may further cause the processor to determine the combination of segments connecting the origin to the destination that satisfies the trip constraint, and that includes the first segment and the second segment connected by the stopover. The instructions may further cause the processor to define the travel proposal to include the combination of segments.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a plurality of computing systems in communication via a network.

FIG. 2 is a diagrammatic view of an exemplary computing system of FIG. 1.

FIG. 3 is a schematic view of a travel planning module that is in communication with a routing database and comprising a calculation engine and a scheduling engine for generating travel proposals.

FIG. 4 is a diagrammatic view of a density sheet used to index segments in the routing database of FIG. 3.

FIG. 5 is a flowchart depicting a process that may be executed by the travel planning module for generating routes connecting an origin to a destination and generating the travel proposals based on the routes.

FIG. 6 is a flowchart depicting additional details of the process of FIG. 5.

FIG. 7 is a flowchart depicting additional details of the process of FIG. 6.

FIG. 8 is a flowchart depicting additional details of the process of FIG. 5.

### DETAILED DESCRIPTION

The methods, systems, and computer program products according to embodiments of the invention may allow generation of optimized travel proposals that satisfy a travel constraint. In particular, embodiments may enable a traveler to plan a trip satisfying a segmentation time constraint without the traveler having to specify in advance a place or time where they desire to include a break in travel, referred to herein as a stopover. Embodiments of the invention may thereby eliminate the need for the traveler to search manually about each possible stopover location, and to investigate about the possible activities or service available in the stopover locations when planning a trip having the segmentation time constraint.

Embodiments of the invention may be implemented by a computing system comprising one or more networked computers or servers. The computing system may provide processing and database functions for travel related systems, such as a travel planning module. The travel planning module may be configured to receive data defining a set of trip requirements for a trip being planned by a traveler. This data may define a starting location or “origin”, an ending location or “destination”, and one or more trip constraints. The trip constraints may include a requirement that the trip include a stopover between segments during which the traveler may disembark from a conveyance, such as a plane, a train, or a bus. The trip constraints may specify that the stopover occur at a particular location, at a particular time, have a particular duration, or include a particular activity. The trip constraints may also specify a constraint on one or more segments of the trip, such as a maximum or minimum allowable segment duration, allowable types of segment (e.g., air, rail, water, or road segment), or a desired combination of types of segments (e.g., a rail segment and an air segment). Data received from the traveler may also include data defining criteria for ranking travel proposals meeting the trip constraints. Based on the received information, the travel planning module may determine a plurality of trip proposals that satisfy the trip constraints, and cause these proposals to be displayed to the traveler.

The travel planning module may thereby enable travelers searching for or making travel arrangements through a travel agency system, such as an on-line travel agency system, to specify the trip constraints and be presented with travel proposals that satisfy the constraints. For example, the traveler may enter a minimum or maximum allowable segment duration, or a minimum or maximum allowable stopover duration. The travel proposals presented to the traveler may be filtered so that only travel proposals that include segments having a duration which corresponds to the allowable segment duration, or that provide the minimum allowable stopover duration, are displayed to the traveler. The traveler may thereby search for travel proposals that satisfy segment and stopover time constraints without a need to specify a particular time or place for the stopover. In particular, embodiments of the invention may eliminate the need for the traveler to search manually about each possible stopover location, or to investigate possible activities or service available at the potential stopovers, in order to book a trip that meets desired segment and stopover requirements.

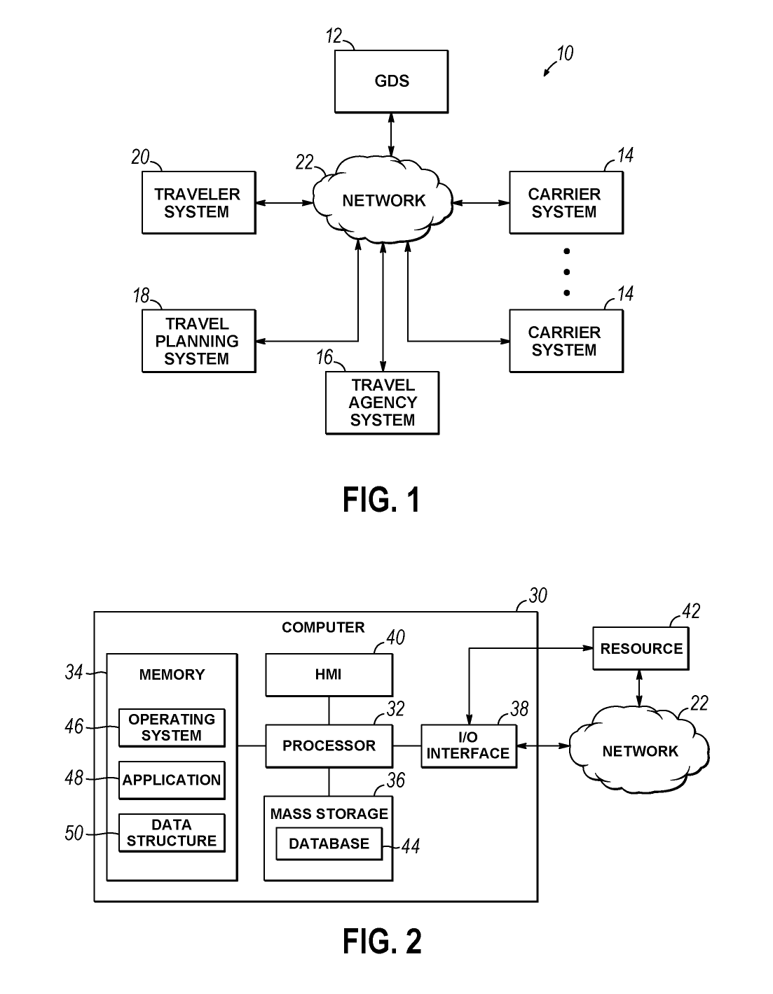

Referring now to FIG. 1, an operating environment 10 in accordance with an embodiment of the invention may include a Global Distribution System (GDS) 12, one or more travel product provider systems, such as carrier systems 14, one or more travel shopping or indirect seller systems, such as a travel agency system 16, a travel planning system 18, and one or more traveler systems 20. Each of the GDS 12, carrier systems 14, travel agency system 16, travel planning system 18, and traveler system 20 may communicate through a network 22. The carrier systems 14 may each include a Computer Reservation System (CRS) and/or billing system for the respective airline that enables the GDS 12 and/or travel agency system 16 to reserve and pay for airline tickets. The carrier systems 14 may also interact with each other, either directly or through the GDS 12, to enable a validating carrier to sell tickets for seats provided by an operating carrier. The operating carrier may then bill the validating carrier for the services provided. The network 22 may include one or more private and/or public networks (e.g., the Internet) that enable the exchange of data.

The GDS 12 may be configured to facilitate communication between the carrier systems 14 and travel agency systems 16 by enabling travel agents, validating carriers, or other indirect sellers to search for available segments and book reservations on one or more carrier systems 14 via the GDS 12. To this end, the GDS 12 may maintain links to each of the carrier systems 14 via the network 22. These links may allow the GDS 12 to obtain scheduling and availability data for segments from the carrier systems 14, and travel proposal reservation requests to the carrier systems 14. The carrier and travel agency systems 14, 16 may thereby book flights, trains, or other types of segments on multiple carriers via a single connection to the GDS 12. The GDS 12 may store and/or maintain a Passenger Name Record (PNR) that includes a complete set of data for an itinerary of a trip, including segments from multiple carriers and/or other travel services comprising the trip such as hotel and rental car reservations.

The travel agency system 16 may include a web server that provides a publicly accessible website. This website may be configured to provide access to travel planning features, such as the ability to search for travel products matching a travel request. To this end, the travel agency system 16 may provide the traveler with access to data from one or more databases hosted by the GDS 12, carrier systems 14, travel agency system 16, and travel planning system 18. In an alternative embodiment of the invention, the travel agency system 16 may be a proprietary system that limits access to travel service providers or travel agents, in which case access may be provided through a private website or other application.

The travel planning system 18 may be in communication with the travel agency system 16 via the network 22 or some other suitable connection. In alternative embodiments of the invention, all or a portion of the travel planning system 18 may be integrated into one or more of the other systems 12, 14, 16, 20. In any case, travelers or travel agents may use the travel agency system 16 to generate and/or search for travel proposals that satisfy a travel request received from the traveler using the travel planning system 18.

The traveler system 20 may be any suitable computing system configured to communicate over the network 22. For example, the traveler system 20 may comprise a desktop, laptop, or tablet computer, a smart phone, or any other computing device that enables the traveler to search for and book travel services over the network 22. In an embodiment of the invention, the traveler system 20 may include a web-browser application that communicates with a web-server application hosted by the travel agency system 16. The web-server application may, in turn, communicate with the GDS 12, carrier systems 14, and/or travel planning system 18 to obtain data relating to available travel segments, and to generate travel proposals that satisfy the travel request.

Referring now to FIG. 2, the GDS 12, carrier systems 14, travel agency system 16, travel planning system 18, and traveler system 20 of operating environment 10 may be implemented on one or more computing devices or systems, referred to collectively as a computer, such as computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 22 and/or I/O interface 38. External resources may include, but are not limited to, servers, databases, mass storage devices, peripheral devices, cloud-based network services, or any other suitable computing resource that may used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 36 may include data storage devices such as a hard drive, optical drive, tape drive, non-volatile solid state device, or any other device capable of storing information. A database 44 may reside on the mass storage memory device 36, and may be used to collect and organize data used by the various systems and modules described herein.

Processor 32 may operate under the control of an operating system 46 that resides in memory 34. The operating system 46 may manage computing resources so that computer program code embodied as one or more computer software applications, such as an application 48 residing in memory 34, may have instructions executed by the processor 32. In an alternative embodiment, the processor 32 may execute the application 48 directly, in which case the operating system 46 may be omitted. One or more data structures 50 may also reside in memory 34, and may be used by the processor 32, operating system 46, and/or application 48 to store or manipulate data.

The I/O interface 38 may provide a machine interface that operatively couples the processor 32 to other devices and systems, such as the network 22 and/or external resource 42. The application 48 may thereby work cooperatively with the network 22 and/or external resource 42 by communicating via the I/O interface 38 to provide the various features, functions, applications, processes, and/or modules comprising embodiments of the invention. The application 48 may also have program code that is executed by one or more external resources 42, or otherwise rely on functions and/or signals provided by other system or network components external to the computer 30. Indeed, given the nearly endless hardware and software configurations possible, persons having ordinary skill in the art will understand that embodiments of the invention may include applications that are located externally to the computer 30, distributed among multiple computers or other external resources 42, or provided by computing resources (hardware and software) that are provided as a service over the network 22, such as a cloud computing service.

The HMI 40 may be operatively coupled to the processor 32 of computer 30 in a known manner to allow a user of the computer 30 to interact directly with the computer 30. The HMI 40 may include video and/or alphanumeric displays, a touch screen, a speaker, and any other suitable audio and visual indicators capable of providing information to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

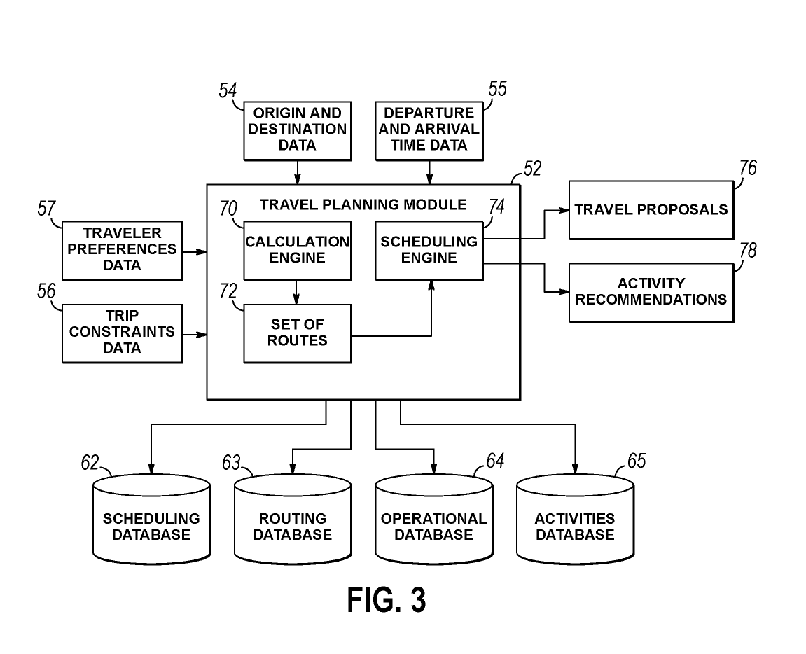

Referring now to FIG. 3 and in accordance with an embodiment of the invention, a travel planning module 52 may be configured to receive data relating to the travel request, such as origin and destination data 54, departure and arrival time data 55, trip constraints data 56, and traveler preferences data 57. The travel planning module 52 may be represented by application 48 (FIG. 2). The origin and destination data 54 may define a starting location-ending location pair (e.g., a city pair), specific locations or points of access in the departure and arrival cities such as airports for flight segments, train stations for rail segments, street addresses for bus or other road-based forms of transportation, or any other suitable starting and ending locations defined by the travel request. The origin and destination data 54 may also define geographic coordinates such as Global Positioning Satellite (GPS) coordinates, or may be converted into geographic coordinates. The origin may be entered by the traveler, or may be determined based on GPS coordinates obtained by the traveler system 20. For example, a traveler system 20 comprising a smart phone or other mobile device may include a GPS receiver, and may provide the traveler's location to the travel planning module 52. The departure and arrival time data 55 may define desired dates and times for departing from the origin and arriving at the destination.

The trip constraints data 56 may define conditions relating to one or more time constraints on one or more of the segments or stopovers comprising the desired trip. These conditions may include: (1) a segment constraint, such as a minimum or maximum allowable segment duration, and (2) a stopover constraint, such as a minimum or a maximum allowable stopover duration. The traveler preferences data 57 may be included in the trip request, or maintained as part of a user profile in a database. The data 54-57 may be received, for example, from the travel agency system 16 in response to the travel agency system 16 receiving the travel request from the traveler system 20.

The traveler preferences data 57 may include data corresponding to traveler inputs identifying options enabled through a user interface. The options selected may depend at least in part on the options provided to the traveler by the travel agency system 16. Exemplary selectable options provided to the traveler may include: (1) a preferred carrier, such as an airline, railway, or bus line; (2) a preferred flight service, such as a charter flight; (3) a preferred connection mode, such as a non-stop or direct segment; (4) a multi-mode option, the selection of which specifies that the trip should include more than one type of segment, such as an air segment and a rail segment; (5) a time sliding window option that automatically shifts the schedule to a time window of ±d days; (6) a traveler type, such as an individual, a corporation, or a travel agency; and (7) specification of a particular connecting location. The traveler preferences data 57 may be used by the travel planning module 52 to determine ranking criteria.

The travel planning module 52 may be in communication with a scheduling database 62, a routing database 63, an operational database 64, and an activities database 65. Each of the databases 62-65 may be represented by database 50 in the 44 (FIG. 2). The travel planning module 52 may include a calculation engine 70 that generates a set of routes 72, and a scheduling engine 74. The scheduling engine 74 may generate travel proposals 76 based on the set of routes 72, taking into account the trip constraints data 56 and the traveler preferences data 57. The travel proposals 76 may be ranked and/or selected based on the ranking criteria. The scheduling engine 74 may also generate one or more activity recommendations 78 based on the stopovers in the travel proposals 76 and data retrieved from the activities database 65.

The scheduling database 62 may provide segment schedule information, such as scheduled departure and arrival times for segments and the carrier providing the segment. The segment schedule information may be used by the travel planning module 52 to generate the travel proposals 76. To this end, the scheduling database 62 may include data relating to available segments provided by the one or more carriers as indexed lists of service information, such as flights, trains, bus routes, as well as identification numbers identifying the service and carrier for each segment. Each segment may define a scheduled transportation service, such as a flight, train, or bus, connecting two locations forming a “market”. The segment may thereby define a specific transportation service that provides one-way travel in the market. Exemplary segments may include, but are not limited to, a non-stop direct transportation service (e.g., a flight having a single leg connecting the market), a direct transportation service with a stop at an intermediate location, and/or a transportation service that includes one or more connections between multiple legs (e.g., a flight that requires the traveler to switch planes).

The scheduling database 62 may include data relating to scheduled segments for one or more carriers. This data may include the starting and ending locations, or the market served by the segment, scheduled departure and arrival times, cost, availability, the type of segment (air, rail, or bus service), the travel time, class of service, and any other data relating to the segment. The scheduling database 62 may thereby provide segment information used to define the travel proposals 76. In an embodiment of the invention, the scheduling database 62 may comprise a plurality of databases each maintained by the carrier providing the segment, a central database that aggregates segment information from a plurality of sources, or a combination of separate and central databases.

The routing database 63 may include data defining markets served by one or more segments provided by the carriers. This data may be indexed by the starting pair that defines the market, and may include data indicative of the distance covered by and the time required to complete each of the segments serving the market, the date or day of the week the segments are available, and the carrier that provides the segment. The routing database 63 may thereby provide data defining one or more transportation networks comprising a plurality of locations, or “nodes” connected by “links”, with each pair of linked nodes corresponding to a market served by at least one segment. For example, a market having at one or more segments could be defined by two nodes connected by a link. Two markets sharing a common location (e.g., Chicago-New York and New York-Paris) could be defined by three nodes (Chicago, New York, and Paris) connected by two links (one or more segments connecting Chicago to New York, and one or more segments connecting New York to Paris).

The routing database 63 may thereby enable the calculation engine 70 to generate routes connecting the origin to the destination by selecting links connecting the nodes corresponding to the origin and destination. These routes may then be used by the scheduling engine 74 to identify scheduled segments in the scheduling database 62 that may be used to generate the travel proposals 76. In an alternative embodiment of the invention, the scheduling database 62 and routing database 63 may be integrated into a single database. The travel planning module 52 may also rely solely on data stored in the scheduling database to generate the travel proposals 76, in which case the routing database may be eliminated. Persons having ordinary skill in the art will therefore understand that embodiments of the invention are not limited to systems including the routing database 63.

The operational database 64 may provide real-time data relating to one-time events that could affect the travel proposals 76. For example, the operational database 64 may include data about current or predicted weather conditions, canceled flights, train derailments, road construction, strikes and other events which may impact the ability of the carriers to provide the scheduled segments. In an embodiment of the invention, the travel planning module 52 may use data provided by the operational database 64 to take into account one-time events when generating the travel proposals. For example, the travel planning module 52 may be configured to check for canceled flights and remove any affected segments from the travel proposal generation process.

The travel planning module 52 may be provided by one or more applications 48 running on one or more computing systems, such as the GDS 12, travel agency system 16, travel planning system 18, as a cloud-based service, or by any other suitable computing system. In an embodiment of the invention, the travel agency system 16 may provide the travel planning module 52 with the data 54-57 used to generate one or more travel proposals 76 and/or activity recommendations 78. The travel proposals 76 and activity recommendations 78 may then be transmitted to the travel agency system 16 for display to the traveler via the traveler system 20.

The travel planning module 52 may be configured to generate travel proposals 76 including two or more segments connecting the origin and destination via a stopover so that each travel proposal satisfies the trip constraints. The trip constraints may also include an activity related constraint, such as a requirement that a restaurant, hotel, or leisure activity be available at or near the stopover location. In this case, the travel planning module 52 may select segments that connect the origin and destination through a stopover location that satisfies the desired activity related constraint.

The travel planning module 52 may filter the travel proposals 76 based on the traveler preferences data 57. The travel planning module 52 may thereby be used to schedule trips having a specific mode of transportation (e.g., air travel only), for a specific carrier (e.g., AIR FRANCE®), or for multiple modes of transportation independent of the carrier. For travel including multiple modes of transportation, the travel proposals 76 may include segments comprising different modes of transportation (e.g., an air segment and a rail segment). In this case, the traveler may specify traveler preferences related to the preferred modes of transportation in the travel request.

The travel request may include data defining the origin and the destination for the requested trip. The origin may correspond to a desired geographical location or departure point where the trip is to begin, while the destination may correspond to a desired geographical location or arrival point where the trip is to end. The traveler may also enter data defining desired departure and arrival dates and times through the user interface. This data may include a desired date and time for departing from the origin, and a desired date and time for arriving at the destination. The traveler may also input data defining one or more traveler preferences that may provide criteria used to rank the travel proposals 76 as discussed above. The travel planning module 52 may use the criteria used to rank the travel proposals so that travel proposals which more closely match the traveler preferences are displayed more prominently to the traveler. For example, the travel planning module 52 may be configured so that out of a total number of travel proposals which satisfy the travel request, just a portion that satisfy the traveler preferences are displayed to the traveler. Exemplary traveler preferences may define ranking criteria including a cost of the segments, preferred modes of transportation or the types of segments comprising the travel proposal, classes of service for the segments, distances of the segments, and desired travel time of the segments over and above any temporal trip constraints.

The segment constraint may comprise one or more time constraints related to a desired segmentation of the trip. For example, the segment constraint may include a time constraint for a segment of the trip (e.g., at least one segment must have a duration greater than the minimum segment time), or for all segments of the trip (e.g., no segment may have a duration exceeding the maximum time constraint). Exemplary segment constraints may include a minimum segment time, which may define a minimum duration that must be provided by at least one segment of the requested trip, and a maximum segment time, which may define a maximum allowable duration for any of the segments.

The minimum segment time constraint may be specified, for example, when the traveler desires an uninterrupted period during a portion of the trip. This uninterrupted period of time may be used by the traveler for a planned activity during the trip, such as working, reading, resting, or any other suitable activity. In an embodiment of the invention, the minimum segment time may be associated with a specific time window. The time window may specify a desired period of time during which the uninterrupted period of time is to occur. To this end, the time of occurrence constraint may define a window of time during which the segment having the minimum duration must occur, or may define a window of time that must fall within the scheduled occurrence of the segment.

The maximum segment time constraint may define the maximum duration that is allowed for any segment of the requested trip. The traveler may specify a maximum segment time if the traveler cannot or does not want to travel continuously for more than the maximum segment time. For example, the traveler may wish to interrupt travel periodically and exit the conveyance for medical reasons or personal comfort. The maximum segment time may thereby allow the traveler to limit the duration of each segment of the trip.

The stopover constraint may define one or more time constraints for one or more stopovers comprising the trip. For example, if the traveler desires a break during the trip, they may specify a stopover constraint that requires a stopover having a duration greater than the minimum allowable stopover duration. Exemplary stopover constraints may include a time constraint defining a desired duration for the stopover, such as a minimum and/or maximum number of minutes/hours for the stopover. The time constraint may be specified by the traveler to ensure that they will have a break of a sufficient duration during the trip to schedule one or more tasks or events that would be difficult or impossible to perform during a segment. For example, the traveler may wish to schedule time to conduct a phone call, connect to the web to check e-mail, have lunch, meet with a client, conduct a business activity, access medical treatment, rest, or schedule a recreational activity such as touring the stopover location. The stopover constraint may define a time window during which the stopover must occur (i.e., the window encompasses the stopover), or a time window that must occur during the stopover (i.e., the window is encompassed by the stopover).

Stopover constraints may also be determined based on data identifying activities that the traveler desires to participate in during the stopover, such as cultural activities or activities provided by facilities at the stopover location. Data identifying desired activities may be included in the travel request submitted by the traveler, or may be determined based on the traveler profile. For example, the travel agency system 16 may maintain a traveler profile in a database. The traveler profile may be created in response to the traveler signing up or otherwise registering as a user on the travel agency system 16. Activity related constraints may also be determined from specific traveler preferences.

The travel planning module 52 may apply the activity related constraints to the process of determining the travel proposals 76 so that the travel proposals 76 accommodate the desired activity. For example, the traveler may specify that the trip include a stopover of at least n hours to provide a break, and an additional trip constraint specifying one or more activities that the traveler wishes to participate in during the break. Exemplary stopover constraints may include: (1) a stopover of n hours for resting, such as by checking into a hotel or by camping; (2) a stopover of n minutes for having a meal in a restaurant or hotel; (3) a stopover of n hours for participating in tourism activities, such as cultural activities, nature activities, or sightseeing; (4) a stopover of n hours for shopping; (5) a stopover of n hours for athletic activities such as walking, swimming, golf, tennis, etc; or (6) a stopover of n hours and m minutes for entertainment, such as attending a theater, a movie, or a concert.

The travel planning module 52 may be configured to take into account the trip constraints when selecting segments and generating travel proposals that connect the origin and destination. Travel planning module 52 may then output travel proposals 76 including segments and stopovers satisfying trip constraints data 56. The travel planning module 52 may also generate travel proposals 76 that take into account stopover activities defined in the travel request or based on the traveler profile. The travel proposals 76 may include a stopover having a duration and location that permits the activities to occur. In addition, the travel planning module 52 may determine activities that are available at the stopover and provide the activity recommendations 78 based on available activities that correspond to the user profile.

In contrast to conventional travel planning products that prioritize continuity and minimizing total travel time, the travel planning module 52 may allow travelers to request travel proposals that take into account trip constraints in a dynamic way. To this end, the travel planning module 52 may optimize the trip proposals around desired temporal requirements. The travel planning module 52 may also apply time continuity constraints, which may be applied to filter segments that also define a trip that satisfies the segment and stopover constraints.

In operation, the traveler may submit the travel request via the user interface. The user interface may be provided, for example, by interaction between the travel agency system 16 and traveler system 20. In an embodiment of the invention, the user interface may be displayed to the traveler by a browser application running on the traveler system 20 in response to accessing a web page generated by a web server application running on the travel agency system 16. The traveler may submit the travel request by entering data into the user interface, such as by filling out a form. The travel planning module 52 may then receive the submitted request, or data extracted or determined from the request.

In response to receiving the travel request, the travel planning module 52 may create a travel request record. The travel request record may comprise fields corresponding to the information contained in the submitted request form together with fields for the segment and stopover constraints. In an embodiment of the invention, the travel planning module 52 may identify the origin and destination defined by the request by, for example, using name recognition functions to scan the travel request. The travel planning module 52 may then determine identifiers associated with the origin and destination using, for example, one or more look-up tables. These identifiers may be used to determine the closest access points for the one or more carriers providing the segments. These access points may then be used to as effective starting and ending locations for the trip.

The calculation engine 70 may be configured to generate the set of routes 72 based on data received from the scheduling database 62 and/or routing database 63. Each route of the set of routes 72 may comprise a combination of links that connect the origination and the destination on the desired dates of travel, and may comprise at least two links connecting the origin and destination through a node corresponding to a stopover location. The travel planning module 52 may create a route record for each route in the set of routes 72. In an embodiment of the invention, the calculation engine 70 may be a non-timetable based engine that relies on routing data stored in the routing database 63. That is, the calculation engine 70 may generate routes connecting the origin and destination without regard to scheduled departure and arrival times for the segments serving the markets comprising the route.

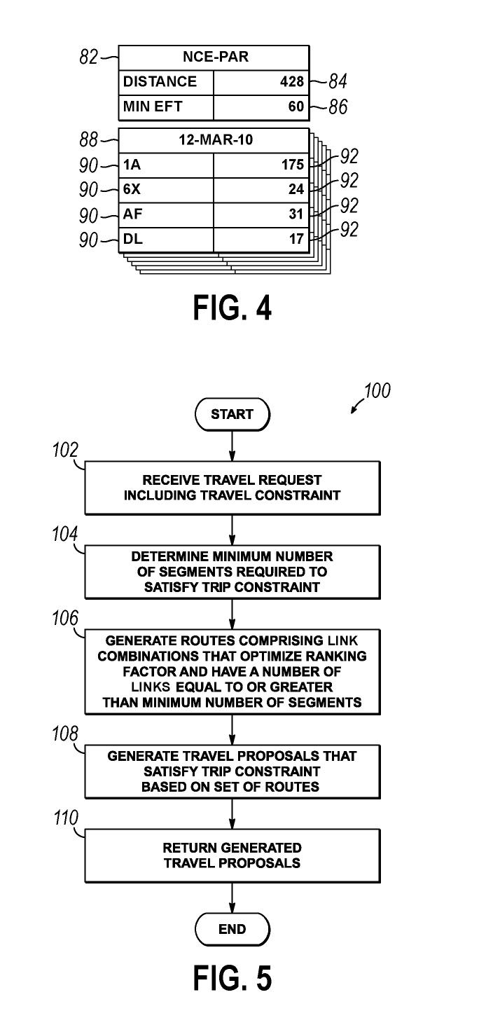

Referring now to FIG. 4, the routing database 63 may organize the segment data into a plurality of density tables 80. Each density table 80 may comprise a specific representation of segment data stored in the scheduling database 62, and may define a set of segments that serve the corresponding market. In an embodiment of the invention, the density tables 80 may be indexed based on the starting location-ending location pair 82 defining the market (e.g., NCE-PAR), and may comprise information about the set of segments serving the market including distance 84 (e.g., 428 km), an estimated travel time 86 (e.g., an estimated flight time or EFT of 60 min), a date 88 on which the segments are available (e.g., 12-MAR-10), one or more carrier codes 90 that identify the carriers that provide the segments (e.g., 1A, 6X, AF, DL), and a corresponding number of services 92 operated in the market by each carrier (e.g., 175 services for carrier 1A). The density tables 80 may be generated based on information received from the scheduling database 62 and stored in the routing database 63 to provide a structured representation of the scheduling database 62.

The routing database 63 may enable the calculation engine 70 to quickly determine routes that connect the origin and destination through one or more stopover locations. The calculation engine 70 may be further configured to rank each route in the set of routes 72 based on the ranking criteria. Criteria used for ranking the routes may include criteria related to travel time, cost, and distance. In an embodiment of the invention, the ranking criteria may be based on traveler preferences, and may be applied based on the content of the density tables 80, e.g., the distance 84 and estimated travel time 86.

To generate the set of routes 72, the calculation engine 70 may determine the best routes in terms of lowest distance or cost to connect the origin and destination. The calculation engine 70 may also generate routes that provide a sufficient number of stopovers to satisfy the trip constraints defined by the trip constraints data 56. Route generation may also take into account activity related constraints. The set of routes 72 may thereby comprise one or more routes comprising two or more links connecting the origin to the destination, or connecting the effective origin and destination locations. Each route may include a minimum number (e.g., at least one) of stopovers at locations that have been determined to be capable of satisfying the trip constraint. In addition, the segments defining each stopover may be selected to optimize travel time, distance, and/or route continuity.

The scheduling engine 74 may be configured to determine which segments are used to populate the routes in the set of routes 72, and which populated routes to select as the travel proposals 76. The scheduling engine 74 may attempt to schedule segments having departure and arrival times that satisfy conditions related to the segment and stopover constraints. Data defining the schedules of the segments may be stored in the scheduling database 62, with each segment being provided by one or more of the carriers. The scheduling engine 74 may obtain available arrival and departure times for the segments comprising the routes, and generate travel proposals that satisfy the trip constraints. By limiting the number of routes that the scheduling engine 74 must analyze to a manageable number, the set of routes 72 may speed generation of the travel proposals 76.

Each of the travel proposals 76 may include at least one “forced” stopover where the traveler will be able to have a break. The stopover may be configured so that the segments comprising the travel proposal satisfy the segment constraints and the activity related constraints. The scheduling engine 74 may further generate activity recommendations 78 based on activities in the activities database 65 available at the time and location of the stopover.

All or a portion of the travel proposals 76 may be displayed on the user interface, and may be displayed according to an order determined based on the ranking criteria. The user interface may also display additional information, such as the cost of each travel proposal. One or more of the activity recommendations 78 may be displayed to allow the travel agency to cross-sell services related to such activities. In an embodiment of the invention, the user interface may be configurable by the traveler so that only certain types of information are displayed in association with the travel proposals 76. For example, the user interface may be configured to display different data if the travel agency system 16 is dedicated to travel agents. The user interface may also display the travel proposals as hyperlinks so that the traveler may be taken to another web page to obtain more information about the travel proposal by selecting the link.

The user interface may be further configured to enable the traveler to book a preferred travel proposal by simply selecting the travel proposal. In response to the traveler selecting the travel proposal, the travel agency system 16 may generate a bookable itinerary for the corresponding trip that lists the carriers providing the segments of the travel proposal. The travel agency system 16 may also facilitate further shopping for the items on the itinerary by transparently connecting to external web sites (e.g., a carrier web site) using the information provided with the travel proposal.

Referring now to FIG. 5, a flowchart is presented that depicts a process 100 which may be executed by the travel planning module 52. In block 102, a travel request is received from a traveler. The travel request may define the origin and destination data 54, the departure and arrival time data 55, and the trip constraints data 56. The travel request may also define all or a portion of the traveler preferences data 57.

In response to receiving the data 54-57, the process 100 may proceed to block 104 and determine a minimum number of segments needed to satisfy the trip constraints. For example, the minimum number of segments needed for a trip having a trip constraint that requires a single stopover may be two segments. In response to determining the minimum number of segments, the process 100 may proceed to block 106.

In block 106, the process 100 may generate the set of routes 72. The links comprising each route of the set of routes 72 may be determined based on data received from the routing database 63. The routes may then be ranked according to the ranking criteria. Exemplary ranking criteria used to rank the routes may include cost, travel time, and/or distance. Each route may be configured so that the route connects the origin and destination through one or more stopover locations, has a number of links that is equal or greater than the minimum number of segments, and optimizes the ranking criteria. The ranking process may be configured, for example, so that the routes having lower relative cost, total travel time, or that cover a shorter distance are ranked higher relative to routes having higher relative cost, total travel time, or that cover a longer distance. In an embodiment of the invention, the set of routes 72 may be filtered based on the traveler preferences data 57 and/or the location or timing of stopover activities. The location, timing, and types of activities available at each stopover may be determined based on data received from the activities database 65. In response to generating the set of routes 72, the process 100 may proceed to block 108.

In block 108, the set of travel proposals 76 may be generated based on one or more routes from the set of routes 72. To this end, the routes may be selected and populated with segments based on the departure and arrival time data 55 and segment schedule data received from the scheduling database 62. A route may be selected if there are combinations of scheduled segments for the links comprising the route that allow the resulting travel proposal to satisfy the trip constraints. Populating the selected routes may include generating one or more combinations of segments connecting the origin and destination by selecting a scheduled segment for each link of the selected route. Because each link may be served by more than one segment, more than one combination of segments may be generated for each route. The travel proposals 76 may then be generated from the combinations of segments satisfying the trip constraints, and the process may proceed to block 110.

In block 110, the set of travel proposals 76 may be displayed to the traveler so that the traveler can select the desired travel proposal. In an embodiment of the invention, the travel proposals 76 may also include an activity recommendation for the stopover locations included in the travel proposal. The process 100 may thereby provide a method of scheduling travel that enables the traveler to overcome the time continuity requirements of conventional travel planning systems. This may be accomplished by enabling the traveler to enter segment and stopover constraints that conventional travel planning methods do not provide.

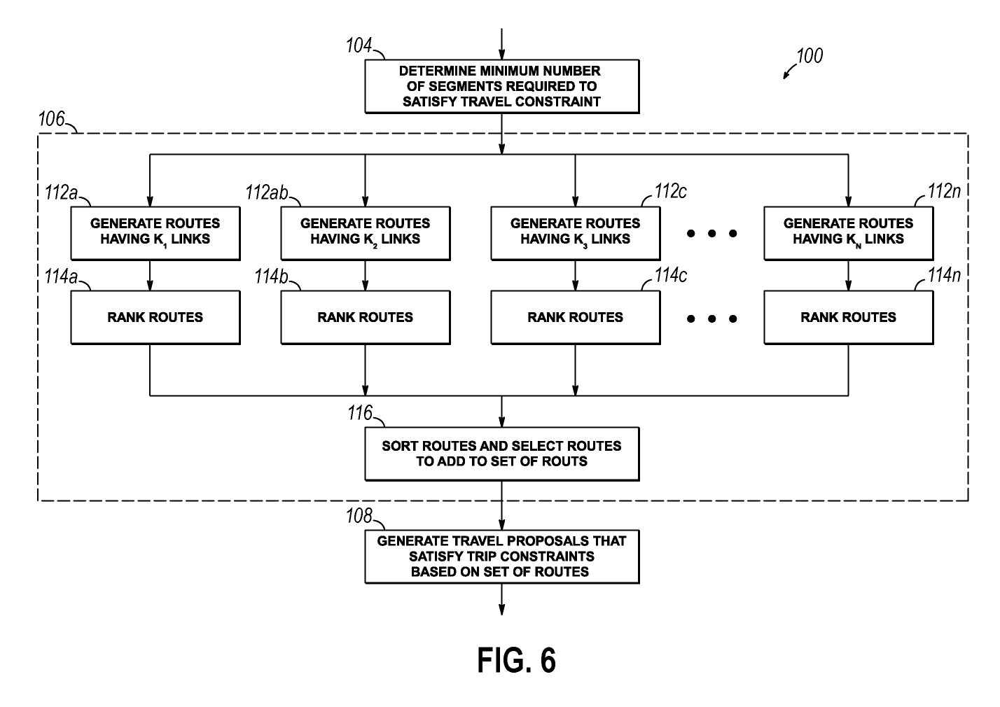

Referring now to FIG. 6, a flowchart is presented in accordance with an embodiment of the invention that depicts the process 100 in more detail with respect to generating the set of routes 72 as described above with respect to block 106. The routes may be generated by selecting combinations of links having k, k+1, k+2, . . . k+n links, either in parallel (as shown) or in a recursive manner, where k=the minimum number of segments required to satisfy the trip constraints. As described above with respect to FIG. 5, the combinations of link comprising the routes may be determined based on data received from the routing database 63.

Each path through block 106 may generate a set of routes having the indicated number of links, so that each route is modeled by a network comprising Kₙ+1 nodes connected by Kₙ links, where n=1 to N. These networks may be configured so that the node representing the origin is connected to the node representing the destination through nodes representing the stopovers, and may be generated based on data received from the routing database 63. That is, each network may include Kₙ links connecting the node representing the origin to the node representing the destination through Kₙ−1 connecting nodes representing the stopover locations. Each model may thereby provide a mathematical representation of the corresponding route suitable for processing by the travel planning module 52.

Each link may correspond to a market for which one or more segments are scheduled, and may be associated with the ranking criteria. The networks may describe routes having one or more links up to the maximum number of K_{N} links. A person having skill in the art would understand that embodiments of the invention may use other methods of defining routes, and is not limited to the network model described above.

In block 112a, the calculation engine 70 may generate routes that have the minimum number of links K₁. The travel planning module 52 may be configured to determine minimum number of links K₁ based on the trip constraints data 56, or the minimum number of links K₁ may be provided to the travel planning module 52. The calculation engine 70 may generate routes having K₁ links that connect the origin to the destination. The routes may be generated based on market information received from the routing database 63, such as the starting location-ending location pair 82, distance 84, estimated travel time 86, or date 88. The calculation engine 70 may also receive other data for use in generating the routes, such as statistical information regarding the markets.

The calculation engine 70 may reject routes that do not satisfy one or more conditions related to stopover-related activity constraints. For example, links that terminate at a stopover location that does not provide a desired local activity may be rejected. The calculation engine 70 may also reject routes having links that cannot satisfy the segment constraints, e.g., the minimum number of segments (K₁ through K_{N} as the case may be), the minimum allowable segment duration, or the maximum allowable segment duration. The selected routes may be added to a subset of routes having K₁ links. In block 114a, ranking criteria may be applied to each route in the subset so that the routes are ranked within the subset based on predefined ranking criteria, such as distance, cost, or estimated travel time.

The above process described with respect to blocks 112a and 114a may be repeated in blocks 112b-112n and blocks 114b though 114n for routes having K₂ through K_{N} links to produce N subsets of ranked routes. This may be done in parallel or sequentially, with a similar process being performed to generate each subset of routes until the N subsets have been generated. In response to the N subsets being generated, the process 100 may proceed to block 116.

In block 116, one or more portions of the subsets of routes may be selected based on the ranking criteria to provide the set of routes 72. For example, a portion of the top ranked routes may be selected from one or more of the subsets. This portion may be filtered based on predefined filtering criteria before adding the portion to the set of routes 72. This may generate a set of routes comprising links that are highly ranked and that are capable of satisfying the segment time constraints.

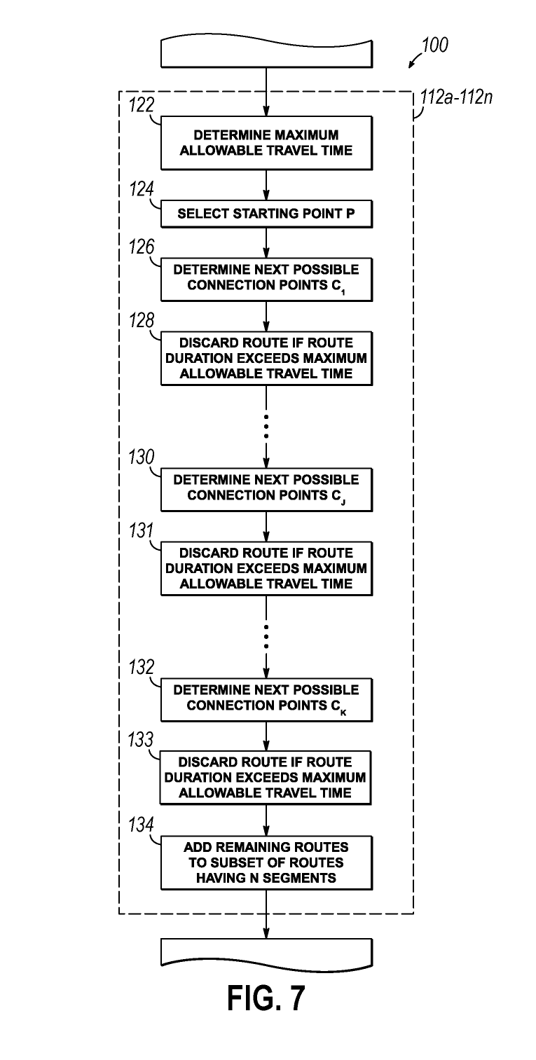

Referring now to FIG. 7, a flowchart is presented in accordance with an embodiment of the invention that depicts the process 100 in more detail with respect to generating routes as described above with respect to blocks 112a-112n. Using the network model to describe the routes, the process 100 may start from the node representing the origin and determine adjacent nodes representing the next possible stopover locations, or connecting nodes C₁ to C_{N+1}. The process 100 may connect additional nodes in series until the resulting route comprises N links connecting the origin node to the destination node through N−1 connecting nodes. By way of example, for N=2, each of the resulting routes may have the same starting and ending node (i.e., the nodes representing the origin and destination, respectively), with each route having a different connecting node C₁.

In block 122, the process may estimate a maximum segment time S_{MAX} based on values of the segment time constraints or other pre-defined parameters. To this end, S_{MAX} may be determined based on one or more of a maximum allowable travel time for the travel proposals 76, and/or one or more segment time constraints (e.g., the minimum or maximum allowable segment duration, if applicable). The maximum allowable travel time may define a maximum amount of time that is acceptable for traveling from the origin to the destination using a specific mode of transportation. The maximum allowable travel time may be computed by the travel planning module 52 using, for example, statistical information relating to the markets represented by the links of the route.

In an embodiment of the invention, the maximum allowable travel time may be determined based on one or more of the segment constraints. For example, if the segment constraint comprises the maximum allowable segment duration, the maximum allowable travel time may be set to the maximum allowable segment duration. That is, the maximum allowable segment duration value may override the predefined maximum allowable travel time. If the segment constraint consists of the minimum allowable segment duration, the maximum allowable travel time may be set to the minimum allowable segment duration if the minimum allowable segment duration is greater than the maximum allowable travel time. In an alternative embodiment of the invention, the maximum allowable travel time may be updated by adding an additional time offset to the minimum allowable segment duration value. The additional time offset value may depend on one or more characteristics of the trip. For example, the additional offset may be added depending on whether the segment corresponds to an international flight or a domestic flight. In response to determining the maximum allowable travel time, the process 100 may proceed to block 124.

In block 124, the process 100 may select a starting point P, which may be the node representing the origin. The process 100 may then proceed to block 126 and determine possible adjacent nodes that could provide connecting nodes C₁. In this exemplary case, the adjacent nodes may correspond to ending locations of segments having starting locations at the current node. The process 100 may then add links to the network model connecting the current node to the adjacent nodes, with the adjacent nodes providing the next layer of connecting nodes C₁. Once the adjacent nodes have been connected to the current node, the process 100 may proceed to block 128.

In block 128, the process 100 may determine the route duration for each of the partially generated routes. The route duration may be determined based on the estimated travel times 86 for the segments serving the links connecting the starting point P to each of the connecting nodes C₁. The process may then discard any partially generated routes having a duration that exceeds the maximum allowable travel time.

In addition to analyzing the links connecting the current node to the next connecting node, the process 100 may determine if the stopover represented by the next connecting node satisfies conditions related to any specified stopover-related activity constraints. More specifically, the activities defined by the stopover-related activity constraints may be compared with data received from the activities database 65.

The activities database 65 may maintain a list of activities indexed by location and/or activity. Exemplary activities may include those related to tourism, dining, and entertainment. Each activity may be associated with a minimum required stopover duration representing the minimum amount of time required to participate in the associated activity. The process 100 may compare activities defined by the stopover-related activity constraints with the activities available at the location corresponding to the current connecting node. The activities available at the location may be determined by querying the activities database 65. If a match is found for at least one activity, these activities may be preselected for inclusion in the travel proposals 76.

For each preselected activity, the minimum required stopover duration associated with the activity may be compared with the stopover duration required by the segment constraints. For example, if the stopover time constraints require the stopover have a duration of N minutes, the current connection location may be a candidate for a stopover if the minimum required stopover duration associated with the preselected activity is less than or equal to the stopover duration. If the stopover duration or available activities for at least one of the stopovers comprising the route cannot satisfy the stopover-related activity constraints, the corresponding route may be discarded. For N greater than 2, the decision to discard the route may be delayed until the route has been completed through N−1 connecting nodes so that each stopover comprising the route may be considered.

As depicted by blocks 130-133, the above process may be repeated for each of the connecting nodes C₂ through C_{K} until the origin node is connected to the destination node by one or more routes comprising K links and K−1 connecting nodes. This process may be repeated in parallel or sequentially for each possible connecting node and value of K until the subsets of routes have been generated for desired number of segments above the minimum number of segments.

The routes generated by the process depicted in FIG. 7 may thereby comprise a set of routes each having N links and conforming to at least a portion of the conditions required by the trip constraints. In response to the next possible connecting node being the node representing the destination, the process 100 may proceed to block 134 and add the routes to the corresponding subset of routes.

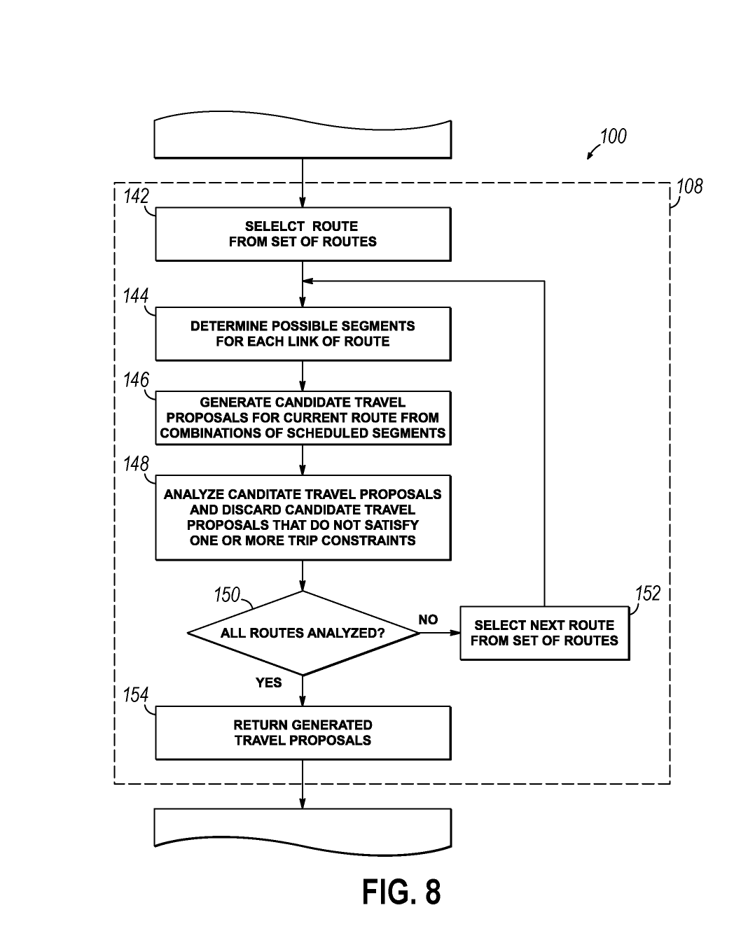

Referring now to FIG. 8, a flowchart is presented in accordance with an embodiment of the invention that depicts the process 100 in more detail with respect to generating the travel proposals 76 as described above with respect to block 108.

In block 142, the scheduling engine 74 may select a route from the set of routes 72 before proceeding to block 144. In block 144, the scheduling engine 74 may determine or otherwise identify the segments scheduled by the carriers for each of the links comprising the selected route. The segments may be determined, for example, by querying the scheduling database 62 for data relating to segments scheduled for the market represented by each link. In response to receiving the data relating to the scheduled segments, the process may proceed to block 146.

In block 146, the process 100 may generate one or more candidate travel proposals for the current route by assigning a scheduled segment to each of the links in the route, or populating the route. The scheduling engine 74 may generate candidate travel proposals representing all possible combinations of scheduled segments for the selected route, only a portion of the total possible combinations, or may determine which segments are compatible with the departure and arrival time data 55 obtained from the travel request and limit the candidate travel proposals to just those segments. In any case, in response to generating the candidate travel proposals, the process 100 may proceed to block 148.

In block 148, the scheduling engine 74 may analyze each candidate travel proposal to determine if the candidate travel proposal satisfies all of the trip constraints. In particular, the scheduling engine 74 may determine if the candidate travel proposals satisfy the segment and stopover time constraints. These constraints may include the minimum and maximum allowable stopover durations, the stopover time window, the minimum and maximum allowable segment durations, and the segment time window. In the case of stopover durations, the search engine may select the larger of the minimum allowable stopover duration and a minimum connecting time for the stopover.

The minimum connecting time may, for example, be an estimated amount of needed time to travel from a disembarkation point of the arriving segment (e.g., arrival gate of a flight) to an embarkation point of the departing segment (e.g., the departure gate of a flight). The minimum connecting time may be predefined for each connection of a schedule combination, and defines the minimal duration required for a traveler to make a given connection. The minimum connecting time may depend on the transportation modes of the connecting segments (e.g., is travel from the airport to a train station required), and may be stored in the scheduling database 62 in association with each connection. In any case, candidate travel proposals that do not satisfy one or more trip constraints may be discarded. The scheduling engine 74 may then proceed to block 150.

In block 150, the process 100 may determine if all routes in the set of routes 72 have been analyzed. If not all of the routes have been analyzed (“NO” branch of decision block 150), the process 100 may proceed to block 152 and select the next route to analyze before returning to block 144. If all the routes have been analyzed (“YES” branch of decision block 150), the process may proceed to block 154 and return the generated travel proposals.

The program code embodying any of the embodiments of the invention described herein is capable of being individually or collectively distributed as a program product in a variety of different forms. In particular, the program code may be distributed using computer-readable media, which may include computer-readable storage media and communication media. Computer-readable storage media, which are inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer-readable instructions, data structures, or other program modules. By way of example, and not limitation, communication media may include wired media such as a wired network or direct-wired connection, and wireless media such as acoustic, RF, infrared and other wireless media. Combinations of any of the above may also be included within the scope of computer-readable media.

The methods described herein can be implemented by computer program instructions supplied to the processor of any type of computer to produce a machine with a processor that executes the instructions to implement the functions/acts specified herein. These computer program instructions may also be stored in a computer-readable medium that can direct a computer to function in a particular manner. To that end, the computer program instructions may be loaded onto a computer to cause the performance of a series of operational steps and thereby produce a computer implemented process such that the executed instructions provide processes for implementing the functions/acts specified herein.

In addition, program code described herein may be identified based upon the application or software component within which the program code is implemented in a specific embodiment of the invention. However, it should be appreciated that any particular program nomenclature that follows is used merely for convenience, and thus the invention should not be limited to use solely in any specific application identified and/or implied by such nomenclature. It should be further appreciated that the various features, applications, and devices disclosed herein may also be used alone or in any combination. Moreover, given the typically endless number of manners in which computer programs may be organized into routines, procedures, methods, modules, objects, and the like, as well as the various manners in which program functionality may be allocated among various software layers that are resident within a typical computing system (e.g., operating systems, libraries, APIs, applications, applets, etc.), and/or across one or more hardware platforms, it should be appreciated that the invention is not limited to the specific organization and allocation of program functionality described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While embodiments of the invention have been illustrated by a description of various examples, and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A method of generating a travel proposal for travel between an origin and a destination, the method comprising:
receiving a travel request at a computer, the travel request including data defining the origin, the destination, and a trip constraint requiring a stopover;
determining, by the computer, a combination of segments connecting the origin to the destination, the combination of segments satisfying the trip constraint and including a first segment and a second segment connected by the stopover; and
defining a first travel proposal that includes the combination of segments.

2. The method of claim 1 wherein the travel request further includes data defining a traveler preference, and further comprising:
defining a second travel proposal satisfying the trip constraint;
defining a ranking criteria based on the traveler preference; and
ranking the first travel proposal and the second travel proposal based on the ranking criteria.

3. The method of claim 2 wherein the traveler preference comprises a preference relating to a carrier, a type of segment, a combination of types of segments, a travel time, a stopover location, or a stopover time.

4. The method of claim 1 wherein determining the combination of segments connecting the origin to the destination comprises:
defining a route including a combination of links connecting the origin to the destination, the combination of links including a first link and a second link;
querying a database for a first set of segments serving the first link;
querying the database for a second set of segments serving the second link;
selecting the first segment from the first set of segments; and
selecting the second segment from the second set of segments.

5. The method of claim 4 further comprising:
determining a minimum number of segments required to satisfy the trip constraint, the combination of links including a number of links greater than or equal to the minimum number of segments.

6. The method of claim 4 wherein the database comprises data defining a schedule of air segments, a schedule of rail segments, or a schedule of bus segments.

7. The method of claim 4 wherein the route is one of a plurality of routes, each route comprising a different combination of links connecting the origin to the destination, and further comprising:
defining a ranking criteria;
ranking the plurality of routes based on the ranking criteria; and
selecting the route from the plurality of routes based on the ranking.

8. The method of claim 7 wherein the ranking criteria comprises a distance of the routes, a travel time of the routes, or a cost of the routes.

9. The method of claim 1 wherein the trip constraint comprises a stopover constraint, a segment constraint, or a time constraint for the first travel proposal.

10. The method of claim 9 wherein the stopover constraint is determined based on a scheduled activity during the stopover.

11. The method of claim 1 further comprising:
selecting an activity for the stopover; and
recommending the activity to a traveler.

12. An apparatus for generating a travel proposal for travel between an origin and a destination, the apparatus comprising:
a processor; and
a memory coupled to the processor and including instructions that, when executed by the processor, cause the apparatus to:
receive a travel request including data defining the origin, the destination, and a trip constraint requiring a stopover;
determine a combination of segments connecting the origin to the destination, the combination of segments satisfying the trip constraint and including a first segment and a second segment connected by the stopover; and
define a first travel proposal that includes the combination of segments.

13. The apparatus of claim 12 wherein the instructions further cause the apparatus to:
define a second travel proposal satisfying the trip constraint;
define a ranking criteria based on the traveler preference; and
rank the first travel proposal and the second travel proposal based on the ranking criteria.

14. The apparatus of claim 12 wherein the instructions cause the apparatus to determine the combination of segments connecting the origin to the destination by:
defining a route including a combination of links connecting the origin to the destination, the combination of links including a first link and a second link;
querying a database for a first set of segments serving the first link;
querying the database for a second set of segments serving the second link;
selecting the first segment from the first set of segments; and
selecting the second segment from the second set of segments.

15. The apparatus of claim 14 wherein the instructions further cause the apparatus to:
determine a minimum number of segments required to satisfy the trip constraint, the combination of links including a number of links greater than or equal to the minimum number of segments.

16. The apparatus of claim 14 wherein the route is one of a plurality of routes, each route comprising a different combination of links connecting the origin to the destination, and the instructions further cause the apparatus to:
define a ranking criteria;
rank the plurality of routes based on the ranking criteria; and
select the route from the plurality of routes based on the ranking.

17. The apparatus of claim 12 wherein the trip constraint comprises a stopover constraint, a segment constraint, or a time constraint for the first travel proposal.

18. The apparatus of claim 17 wherein the stopover constraint is determined based on a scheduled activity during the stopover.

19. The apparatus of claim 12 wherein the instructions further cause the apparatus to:
select an activity for the stopover; and
recommend the activity to a traveler.

20. A computer program product comprising:
a non-transitory computer readable storage medium; and
instructions stored on the non-transitory computer readable storage medium that, when executed by a processor, cause the processor to:
receive a travel request including data defining the origin, the destination, and a trip constraint requiring a stopover;
determine a combination of segments connecting the origin to the destination, the combination of segments satisfying the trip constraint and including a first segment and a second segment connected by the stopover; and
define a first travel proposal that includes the combination of segments.
